(19) United States
(12) Patent Application Publication
(10) Pub. No.: US 2010/0140421 A1
(43) Pub. Date: Jun. 10, 2010

(54) UP-AND-DOWN APPARATUS OF THE ADAPTER

(76) Inventor: Bong-Joo Lee, Bucheon-si (KR)

Correspondence Address: SUGHRUE MION, PLLC, 2100 PENNSYLVANIA AVENUE, N.W., SUITE 800, WASHINGTON, DC, 20037, US

(21) Appl. No.: 12/598,732

(22) PCT Filed: Jun. 2, 2008
(86) PCT No.: PCT/KR2008/003081

§ 371 Date: Nov. 3, 2009

(30) Foreign Application Priority Data
Jun. 5, 2007 (KR) 10-2007-0054769

(51) Int. Cl. F16L 3/00; F16L 3/16

(52) U.S. Cl. 248/59

(57) ABSTRACT

A device for raising and lowering an adapter. A slider having an adapter fastened thereto is assembled to a frame such that the slider can be raised and lowered, and hinge parts of a lever moving member having a stop lever assembled thereto are assembled to hinge parts of the frame by way of springs. The stop lever is always biased toward stopper grooves of the slider by spring force of the springs so that engagement teeth of the stop lever are engaged in the stopper grooves so as to maintain the slider in a fixed state. When the stop lever is moved rightward by manipulating the lever moving member, the engagement teeth of the stop lever are disengaged from the stopper grooves of the slider so that the slider can be freely raised and lowered.

### TECHNICAL FIELD

The present invention relates to a device for raising and lowering an adapter, which can change the vertical position of an adapter used in the installation of a water spraying device such as a sprinkler head on the ceiling of a building so that the height of the adapter can be precisely adjusted when fastening the adapter to the ceiling.

### BACKGROUND ART

In general, a sprinkler is used to scatter water so as to extinguish the fire of a building or supply water to crops. Also, a tap is used to supply water for drinking purpose. In order to layout piping for the sprinkler or the tap, a main pipe is extended from a water source for supplying water, and pipe fittings such as tees and elbows are installed at necessary places on the main pipe. The sprinkler or the tap as a piping element (hereinafter, referred to as a “piping target” as a final object to be finally connected in piping work) is installed on a port branched from the pipe fittings by the use of an intermediate member such as a nipple or a flexible tube.

When performing ceiling installation work during the installation of the sprinkler as a piping target to the ceiling of a building, before connecting a sprinkler head to the ceiling, an adapter is first fastened to the ceiling. Then, the piping target is connected to one end of the adapter, and a water pipe or a corrugated pipe is connected to the other end of the adapter.

FIG. 31 is a view illustrating a state in which a sprinkler head (a piping target) used for fire extinguishing purpose is installed on the ceiling of a building by the use of an adapter as an intermediate member according to the conventional art. A frame B is fastened to a concrete ceiling T1 using fastening nails K, and an adapter A is assembled to the frame B such that it can be moved upwards and downwards along a groove B1 defined in the frame B. A corrugated pipe P is connected to one end of the adapter A using a cap nut N so that water from a water source can be supplied, and a sprinkler head S is assembled to the other end of the adapter A. A hole h defined in a gypsum board ceiling T2 is covered using a finishing cover C.

In this regard, since the gap between the concrete ceiling T1 and the gypsum board ceiling T2 varies depending upon whether the location is an apartment or a mixed-use apartment, the installation position (height) of the sprinkler head S also varies. If the installation height of the sprinkler head S is not precisely adjusted, sprinkler heads S cannot but project out of the gypsum board ceiling T2 by different lengths. Therefore, in this state in which the projecting lengths of the sprinkler heads S are not constant, even when the finishing cover C is placed on the gypsum board ceiling T2, the holes h defined in the gypsum board ceiling T2 cannot be covered in an aesthetically appealing way. That is to say, since the gap between the gypsum board ceiling T2 and the fining cover C becomes irregular, the aesthetic appearance of the ceiling is likely to be deteriorated.

For this reason, in order to constantly set the installation heights of adapters A used for assembling the sprinkler heads S, a driver D is rotated to rotate a height adjustment bolt E. By this fact, an adapter bracket A2 assembled to the height adjustment bolt E can be moved upwards and downwards, and the adapter A which is fastened to the adapter bracket A2 can be moved upwards or downwards, so that the installation height of the adapter A can be adjusted as desired.

However, in order to perform the height adjustment work for the adapter A as described above, a lengthy period is required to rotate the driver, and the neck of a worker who must perform the work while facing the ceiling is likely to ache. Further, in the event that the hole h defined in the gypsum board ceiling T2 is not large enough, the bolt head of the height adjustment bolt E can be hid by the gypsum board ceiling T2 and cannot be properly seen by the eyes of the worker, whereby it is difficult for the worker to align the driver with the bolt head. Moreover, in the worst case, if the driver is obliquely aligned with the bolt head, the driver is likely to be released while rotating the driver, whereby problems are caused in that it is troublesome and time-consuming for the worker to rotate the driver.

### DISCLOSURE OF INVENTION

### Technical Problem

Accordingly, the present invention has been made in an effort to solve the problems occurring in the related art, and an object of the present invention is to provide a device for raising and lowering an adapter, wherein a slider is formed to have a plurality of stopper grooves, an adapter and the slider are assembled to a frame such that they can be raised and lowered in the frame, a stop lever is formed to have engagement teeth to be engaged in the stopper grooves of the slider, and a lever moving member for moving the stop lever leftward and rightward is arranged so that the stop lever can be moved leftward and rightward through manipulation of the lever moving member. Therefore, with the engagement teeth of the stop lever engaged in the stopper grooves of the slider, the slider is held against the upward and downward movement even when high water pressure or instantaneous water pressure is applied to the adapter, thus preventing the adapter from being moved upward and downward and maintaining it in a fixed state. Further, with the stop lever moved rightward through simple manipulation of the lever moving member and thereby disengaging the engagement teeth of the stop lever from the stopper grooves of the slider, the height of the adapter can be adjusted. As a consequence, because the installation height of the adapter can be quickly and precisely adjusted through a simple process, advantages are rendered in that costs incurred by piping work can be significantly reduced.

### Technical Solution

In order to achieve the above object, according to one aspect of the present invention, there is provided a device for raising and lowering an adapter, in which an adapter is assembled to a frame such that the adapter can be raised and lowered along the frame, the device comprising a slider having a body on which a plurality of stopper grooves are formed; a frame having a body which functions to guide upward and downward movement of the slider and on which a first slide groove and hinge parts are formed; a lever bracket having a body which is secured to the frame and in which a second slide groove is formed; a stop lever having a body which can be moved leftward and rightward through the first and second slide grooves and on which a hook and engagement teeth are formed; a lever moving member having a body which functions to move the stop lever leftward and rightward and on which a hook fitting part and hinge parts are formed; and springs, wherein, by hinge-coupling the stop lever and the lever moving member to the frame by way of the springs, the engagement teeth of the stop lever are forced by spring force of the springs to be engaged in the stopper grooves of the slider. In the device for raising and lowering an adapter constructed in this way, by moving the stop lever leftwards and rightwards through manipulating the lever moving member, selection can be made between a stopped state (a fixed state) in which the engagement teeth of the stop lever are engaged in the stopper grooves of the slider and a free state (a released state) in which the engagement teeth of the stop lever are disengaged from the stopper grooves of the slider so that the slider having the adapter fastened thereto can be freely moved upwards and downwards.

In a mounted state wherein the device for raising and lowering an adapter constructed as described above is mounted to a ceiling, when it is necessary to adjust the installation height of the adapter, by manipulating the lever moving member assembled to the frame, the stop lever is moved rightward to disengage the engagement teeth from the stopper grooves of the slider, whereby the slider and the adapter can be freely moved upwards or downwards with respect to the frame.

In this free state, the precise installation height can be adjusted by moving the slider and the adapter in the upward and downward directions. Once the precise installation height of the adapter is achieved, the adapter movement is stopped at that position. Then, by manipulating again the lever moving member, the stop lever is moved leftward such that the engagement teeth of the stop lever are engaged in the stopper grooves of the slider, whereby the adapter can be maintained in a fixed state so that it cannot be moved any more in the upward and downward directions.

As a consequence, the installation position (height) of the adapter can be conveniently and quickly adjusted through the simple manipulation of the lever moving member, and in the adjusted position, the adapter is maintained in the stopped state so that it cannot be moved any more upwards and downwards. Thus, even when strong shocks or substantial water pressure is externally or internally applied to a piping target while the piping target is used in a state in which it is coupled to the adapter, the adapter can be firmly secured in the installation position without being moved upwards or downwards.

### ADVANTAGEOUS EFFECTS

In the device for raising and lowering an adapter according to the present invention, the slider is formed to have the plurality of stopper grooves, and the adapter is fastened to the slider. The slider having the adapter fastened thereto is assembled to the frame such that it can be moved upwards and downwards. The stop lever is provided to be engaged in the stopper grooves of the slider to thereby prevent the adapter from being moved downwards. At this time, by moving the stop lever leftwards and rightwards through manipulating the lever moving member, selection can be made between the stopped state (the fixed state) in which the engagement teeth of the stop lever are engaged in the stopper grooves of the slider and the free state (the released state) in which the engagement teeth of the stop lever are disengaged from the stopper grooves of the slider. Therefore, by manipulating the lever moving member and thereby disengaging the stop lever from the stopper grooves of the slider, the slider and the adapter can be maintained in the free state in which they can be freely moved upwards and downwards in the frame. Also, by manipulating again the lever moving member and thereby engaging the stop lever in the stopper grooves of the slider, the adapter can be maintained in the fixed state in which it cannot be moved any more upwards and downwards.

Hence, since the installation position (height) of the adapter can be conveniently and quickly adjusted through simple manipulation of the lever moving member, a procedure for adjusting the installation position (height) of the adapter can be simply implemented within a short time period. Also, because the number of workers can be decreased, advantages are provided in terms of the simplification of piping work, shortening of the time required for the piping work, and reduction of costs incurred by the piping work. Furthermore, even when strong shocks or substantial instantaneous water pressure is externally or internally applied to the adapter while the adapter is installed and used, the adapter can be reliably and firmly secured at the installation position without being moved upwards and downwards.

### BRIEF DESCRIPTION OF THE DRAWINGS

FIG. 1 is a plan view illustrating an adapter used in a device for raising and lowering an adapter in accordance with the present invention.

FIG. 2 is a sectional view illustrating the adapter used in the device for raising and lowering an adapter in accordance with the present invention.

FIG. 3 is a front view illustrating a slider used in the device for raising and lowering an adapter in accordance with the present invention.

FIG. 4 is a bottom view illustrating the slider used in the device for raising and lowering an adapter in accordance with the present invention.

FIG. 5 is a sectional view taken along the line A-A of FIG. 3.

FIG. 6 is a front view illustrating a frame used in the device for raising and lowering an adapter in accordance with the present invention.

FIG. 7 is a bottom view illustrating the frame used in the device for raising and lowering an adapter in accordance with the present invention.

FIG. 8 is a sectional view taken along the line C-C of FIG. 6.

FIG. 9 is a rear view illustrating the frame used in the device for raising and lowering an adapter in accordance with the present invention.

FIG. 10 is a perspective view illustrating a lever bracket used in the device for raising and lowering an adapter in accordance with the present invention.

FIG. 11 is a sectional view taken along the line D-D of FIG. 10.

FIG. 12 is a plan view illustrating a stop lever used in the device for raising and lowering an adapter in accordance with the present invention.

FIG. 13 is a sectional view taken along the line E-E of FIG. 12.

FIG. 14 is a right side view illustrating the stop lever used in the device for raising and lowering an adapter in accordance with the present invention.0

FIG. 15 is a plan view illustrating a lever moving member used in the device for raising and lowering an adapter in accordance with the present invention.

FIG. 16 is a sectional view taken along the line F-F of FIG. 15.

FIG. 17 is a right side view illustrating the lever moving member used in the device for raising and lowering an adapter in accordance with the present invention.

FIG. 18 is an exploded sectional view illustrating an auxiliary lever moving member used in the device for raising and lowering an adapter in accordance with the present invention.

FIG. 19 is a view illustrating a state in which the device for raising and lowering an adapter in accordance with the present invention is assembled and engagement teeth of the stop lever are engaged in stopper grooves of the slider.

FIG. 20 is a view illustrating a state in which the device for raising and lowering an adapter in accordance with the present invention is installed on the ceiling of a building.

FIG. 21 is a view illustrating a state in which the device for raising and lowering an adapter in accordance with the present invention is assembled and the engagement teeth of the stop lever are disengaged from the stopper grooves of the slider.

FIG. 22 is a view illustrating a state in which the auxiliary lever moving member is joined to the device for raising and lowering an adapter in accordance with the present invention.

FIG. 23 is a view illustrating a state in which the device for raising and lowering an adapter in accordance with the present invention is installed on the ceiling of a building with the auxiliary lever moving member jointed thereto.

FIG. 24 is a view illustrating the use of the device for raising and lowering an adapter in accordance with the present invention with the auxiliary lever moving member jointed thereto.

FIG. 25 is a front view illustrating a variation of the slider used in the device for raising and lowering an adapter in accordance with the present invention.

FIG. 26 is a bottom view illustrating the slider shown in FIG. 25.

FIG. 27 is a sectional view taken along the line G-G of FIG. 25.

FIG. 28 is a plan view illustrating a variation of the stop lever used in the device for raising and lowering an adapter in accordance with the present invention.

FIG. 29 is a sectional view taken along the line H-H of FIG. 28.

FIG. 30 is a right side view illustrating the stop lever shown in FIG. 28.

FIG. 31 is a view illustrating the installation state of a conventional device for raising and lowering an adapter.

### DESCRIPTION OF REFERENCE NUMERALS FOR MAIN PARTS IN DRAWINGS

1: adapter 2, 8: slider

3: frame 4: lever bracket

5, 9: stop lever 6: lever moving member

### MODE FOR THE INVENTION

Reference will now be made in greater detail to a preferred embodiment of the invention, an example of which is illustrated in the accompanying drawings.

In a device for raising and lowering an adapter according to the present invention, an adapter 1 is fastened to a slider 2 which has a plurality of stopper grooves 24 defined therein. The slider 2 is assembled to a frame 3 such that it can slide upwards and downwards along the frame 3. A stop lever 5 and a lever moving member 6 are also assembled to the frame 3. Depending upon the manipulation of the lever moving member 6, the stop lever 5 can be moved leftward and rightward such that the engagement teeth 54 of the stop lever 5 can be engaged in or disengaged from the stopper grooves 24 of the slider 2, whereby the adapter 1 and the slider 2 can be selectively placed under a stopped state in which they are held in a desired fixed position (height) and a free state in which they can be freely moved upwards and downwards.

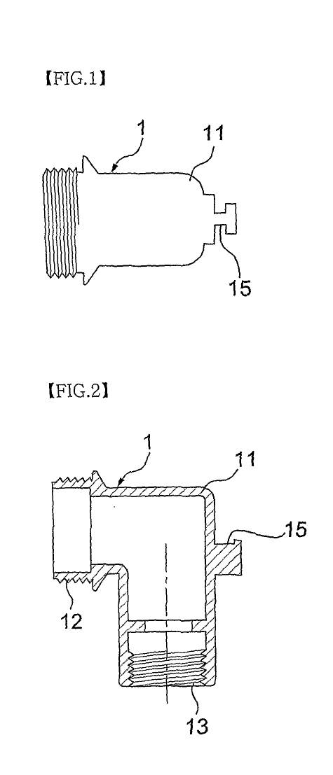

FIGS. 1 and 2 are a plan view and a sectional view illustrating the adapter 1 used in the device for raising and lowering an adapter in accordance with the present invention.

The adapter 1 has a body 11 on which a water supply pipe connection part 12 for connecting a water pipe for the supply of city water and a piping target connection part 13 for the connection of a piping target are formed. The adapter body 11 also has a fastening part 15 to be fastened to the slider 2.

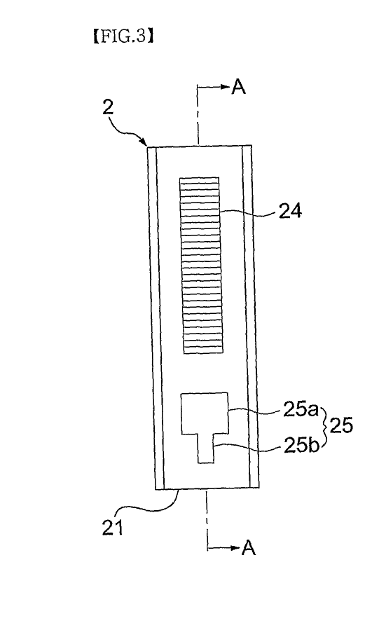

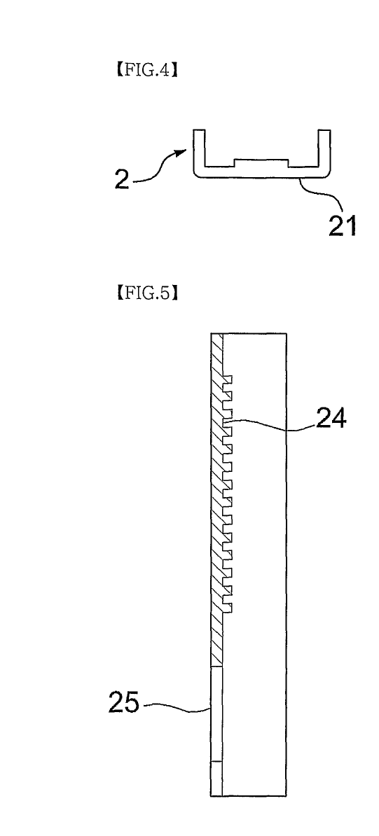

FIGS. 3 through 5 are a front view, a bottom view and a sectional view illustrating the slider 2 to which the adapter 1 is fastened and which can slide upwards and downwards along the frame 3 together with the adapter 1 fastened in this way, in the device for raising and lowering an adapter in accordance with the present invention.

The slider 2 has a body 21 on which the plurality of stopper grooves 24 are defined. Also, an adapter fastening part 25 for fastening the adapter 1 is formed in the slider body 21. The adapter fastening part 25 has an adapter fitting groove 25a at the upper portion thereof and an adapter fastening groove 25b at the lower portion thereof, such that the fastening part 15 of the adapter 1 can be fitted into the adapter fitting groove 25a and then the adapter can be lowered and firmly fastened in the adapter fastening groove 25b.

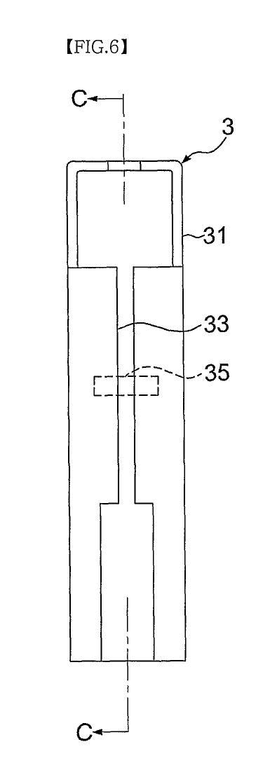

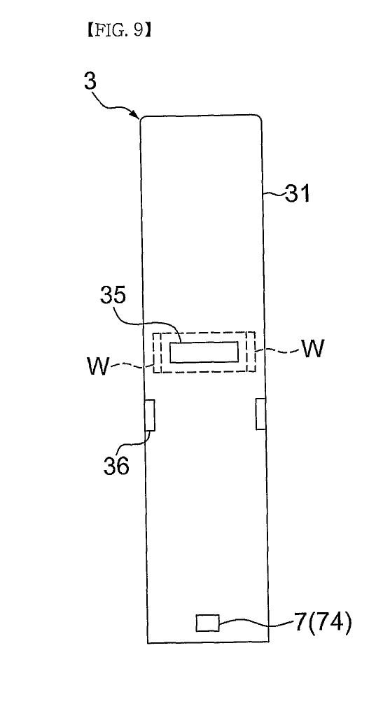

FIGS. 6 through 9 illustrate the frame 3 to which the slider 2 is assembled along with the adapter 1 such that they can be moved upwards and downwards, in the device for raising and lowering an adapter in accordance with the present invention.

The frame 3 has a body 31 in which a frame fastening part 32 for fastening the frame 3 to a ceiling is formed. A guide part 33 is defined in the frame body 31 to guide the upward and downward movement of the slider 2 assembled in the frame body 31. Also, a first slide groove 35 is defined in the frame body 31 to permit the free leftward and rightward sliding movement of the stop lever 5. Hinge parts 36 are formed on the lower end of the frame body 31 to assemble the lever moving member 6 using hinges.

An auxiliary lever moving member guide part 74 for assembling an auxiliary lever moving member 7 (to be described later), which is provided to allow the lever moving member 6 to be manipulated using a hand or a simple tool, is attached to the lower end of the frame body 31. In the case that the lever moving member 6 is manipulated not using the auxiliary lever moving member 7 but directly using a hand or a tool, the auxiliary lever moving member guide part 74 can be omitted.

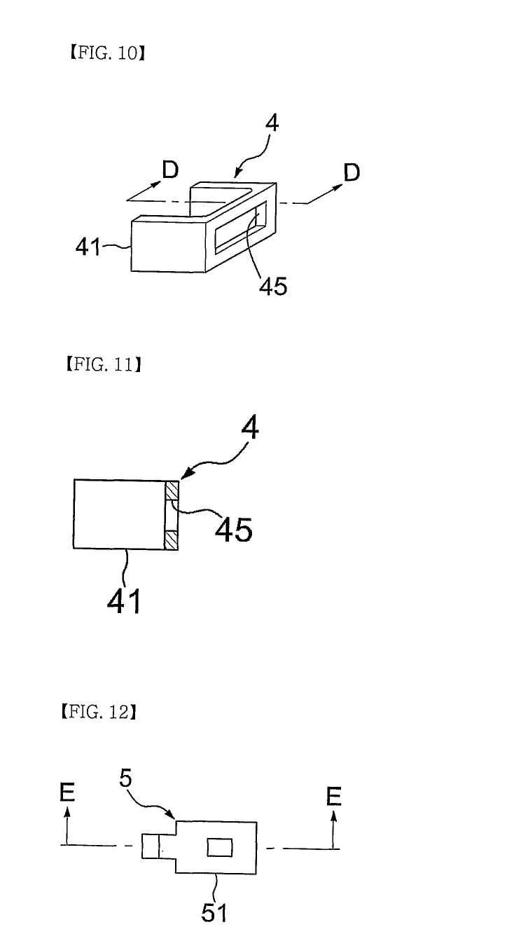

FIGS. 10 and 11 are a perspective view and a sectional view illustrating the lever bracket 4 which is provided to ensure the stable leftward and rightward movement of the stop lever 5.

The lever bracket 4 has a body 41 in which a second slide groove 45 is defined. Preferably, the second slide groove 45 is defined to be similar to the first slide groove 35 defined in the frame 3 in sectional shape and size. The lever bracket 4 formed in this way is secured to the frame 3 through welding or conventional methods known in the art.

Further, preferably, the lever bracket 4 is secured to the frame 3 such that the second slide groove 35 of the lever bracket 4 is substantially aligned with the first slide groove 35 of the frame 3 in the horizontal direction.

This is because, in the present invention, the stop lever 5 must be moved leftward or rightward through the first slide groove 35 of the frame 3 and the second slide groove 45 of the lever bracket 4 by manipulating the lever moving member 6. That is to say, when the stop lever 5 is moved in the horizontal direction to allow the engagement teeth 54 of the stop lever to be engaged in the stopper grooves 24 of the slider 2, the fixed position and the free position of the adapter 1 can be reliably ensured, and the securely fixed state of the adapter 1 can be maintained.

However, in the case that the engagement or disengagement of the stop lever 5 can be ensured through other ways, the horizontal alignment is not necessarily required.

FIGS. 12 through 14 are a plan view, a sectional view and a right side view illustrating the stop lever 5 which is assembled to the frame 3 and is teeth-engaged in the stopper grooves 24 of the slider 3 to control the upward and downward movement of the slider 2.

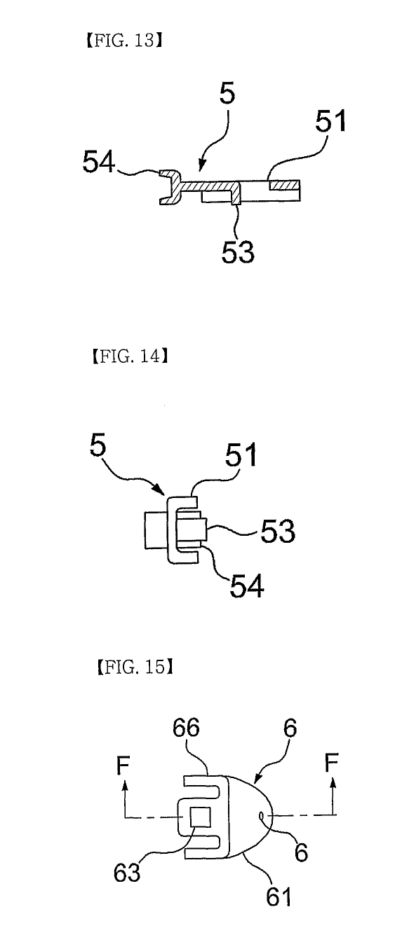

The stop lever 5 has a body 51 on which a hook 53 for being fitted into the lever moving member 6 is formed. The engagement teeth 54 for being engaged in the stopper grooves 24 of the slider 2 are formed on one end of the stop lever body 51. FIG. 13 illustrates a state in which two engagement teeth 54 are formed up and down. This is to reliably maintain the adapter 1 in the securely fixed state even when substantial water pressure is downwardly or upwardly applied to the adapter 1 while the piping target is being used. If the securely fixed state of the adapter 1 can be maintained with only one tooth, only one engagement tooth need be employed.

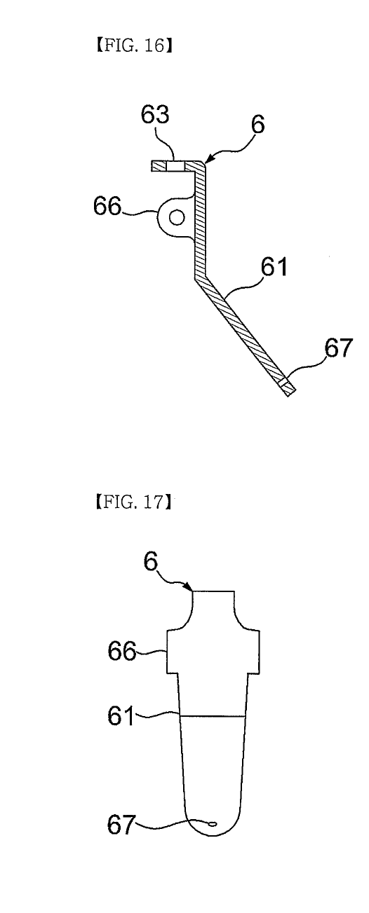

FIGS. 15 through 17 are a plan view, a sectional view and a right side view illustrating the lever moving member 6 for manipulating the leftward and rightward movement of the stop lever 5.

The lever moving member 6 has a body 61 on the upper end of which a hook assembling part 63 for fitting the hook 53 of the stop lever 5 is formed. Also, hinge parts 66 for being assembled with the hinge parts 36 formed on the frame 3 using hinges are formed on the lever moving member body 61. A hole 67 for the assembly of the auxiliary lever moving member 7 is defined through the lower end portion of the lever moving member body 61. If the auxiliary lever moving member 7 is not needed, the hole 67 can be omitted. Hinge pins ‘p’ and springs ‘s’ are prepared to hingedly assemble the two hinge parts 36 and 66.

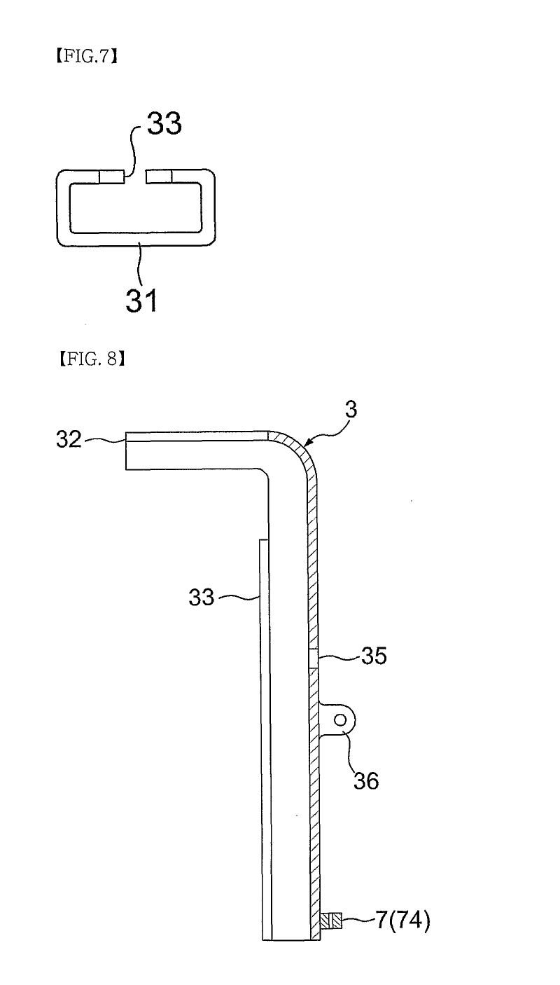

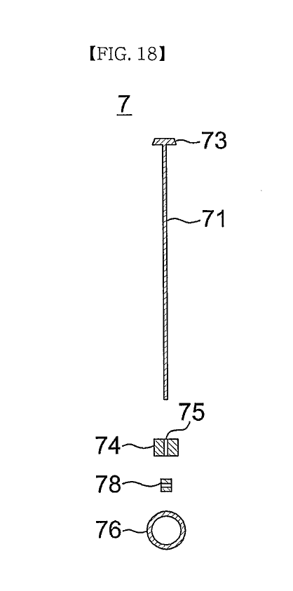

FIG. 18 is an exploded sectional view illustrating the auxiliary lever moving member 7 which is separately formed to be used when it is determined that it is convenient to manipulate the lever moving member 6 by the medium of an auxiliary operation mechanism rather than by directly using the hands or a tool. The auxiliary lever moving member 7 has a manipulation cord 71. A connection piece 73 is secured to one end of the manipulation cord 71. The guide part 74 for changing the moving direction of and guiding the manipulation cord 71 is formed. The guide part 74 is attached to the lower end of the frame body 31 of the frame 3 (see FIG. 8). A guide hole 75 for permitting the passage of the manipulation cord 71 is defined through the guide part 74. An operation knob 76, to which the other end of the manipulation cord 71 is knotted, is provided.

The reference numeral 78 designates a knot which is used to join the other end of the manipulation cord 71 to the operation knob 76. As the knot 78, the other end of the manipulation cord 71 can be passed through the hole 67 of the lever moving member 6 and the guide hole 75 and then be directly knotted to the operation knob 76, or the manipulation cord 71 and the operation knob 76 can be bonded to each other using an adhesive or molded with each other using synthetic resin.

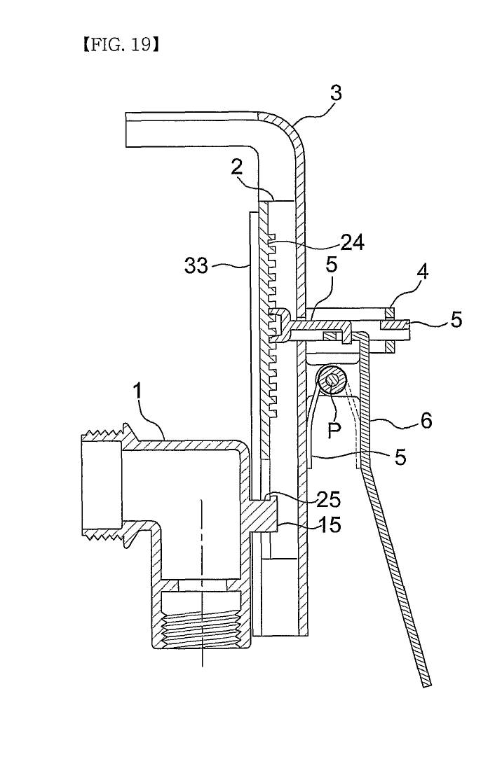

FIG. 19 is a view illustrating a state in which the device for raising and lowering an adapter in accordance with the present invention is assembled and the stop lever 5 is engaged in the slider 2.

In the device for raising and lowering an adapter in accordance with the present invention, the fastening part 15 of the adapter 1 is fitted and fastened in the adapter fastening part 25 of the slider 2, and the slider body 21 is fitted between the frame body 31 and the guide part 33 of the frame 3, such that the slider 2 can be moved along with the adapter 1 upward and downward in the frame 3.

Further, the stop lever body 51 of the stop lever 5 is passed through the first slide groove 35 of the frame 3, and the hook 53 of the stop lever 5 is fitted through the hook assembling part 63 of the lever moving member 6. In this state, the hinge parts 66 of the lever moving member 6 are assembled with the hinge parts 36 of the frame 3 by way of the springs ‘s’ and the hinge pins ‘p’, and the lever bracket 4 is welded to the frame 3 along a welding line ‘W’.

By assembling the two hinge parts 36 and 66 by way of the springs ‘s’ in this way, the spring force of the springs ‘s’ is applied to the lower portion of the lever moving member 6 about the hinge pins ‘p’ in such a way as to separate the lower portion of the lever moving member 6 from the frame 3. Accordingly, the spring force of the springs ‘s’ is applied to the upper portion of the lever moving member 6 in such a way as to bias the upper portion of the lever moving member 6 toward the frame 3. Thus, the lever moving member 6 pushes the hook 53 of the stop lever 5 toward the slider 2, and therefore, the engagement teeth 54 of the stop lever 5 are engaged in the stopper grooves 24 of the slider 2, whereby the slider 2 and the adapter 1 are maintained in fixed state.

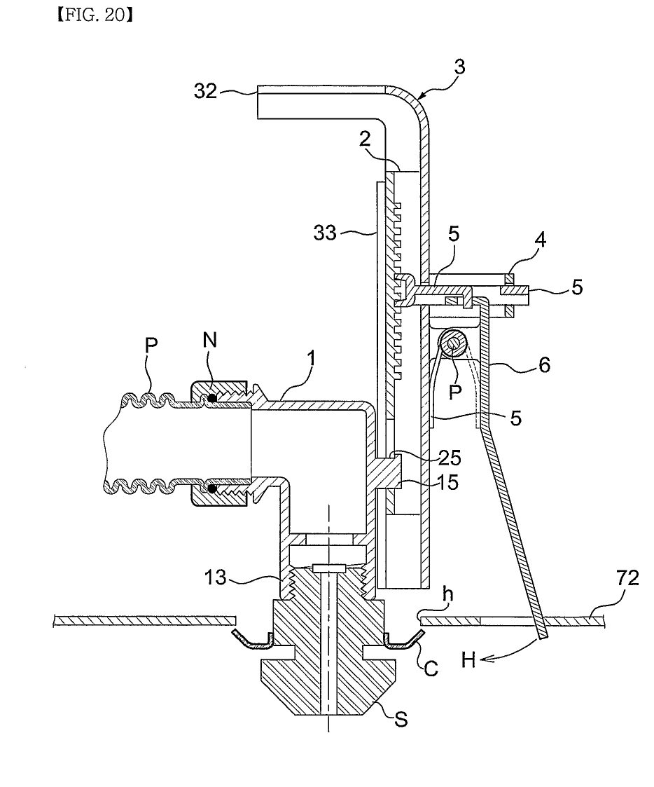

FIG. 20 is a view illustrating a state in which the device for raising and lowering an adapter in accordance with the present invention is installed on the ceiling of a building.

In the device for raising and lowering an adapter according to the present invention, in which the adapter 1 is fastened to the slider 2, the slider 2 is assembled to the frame 3 such that it can be moved upward and downward along the guide part 33 of the frame 3, and the stop lever 5 and the lever moving member 6 are assembled to the frame 3 through fitting, the fastening part 32 of the frame 32 is fastened to a concrete ceiling using fastening nails, and a corrugated pipe P is connected to one side of the adapter 1 using a cap nut N.

After the adapter 1 is precisely positioned in this way, a sprinkler head S is assembled to the piping target connection part 13 of the adapter 1, and a hole ‘h’ defined in a gypsum board ceiling T2 is covered using a finishing cover C.

As a consequence, in the state assembled as described above, even when high impulsive water pressure or internal water pressure is applied to pipe fittings such as the sprinkler, the adapter, or other parts, the engagement teeth 54 of the stop lever 5 stably and firmly remain firmly engaged in the stopper grooves 24 of the slider 2. Hence, the slider 2, that is, the adapter 1 cannot be moved upwards or downwards and is maintained in the fixed state to function in a reliable and stable manner.

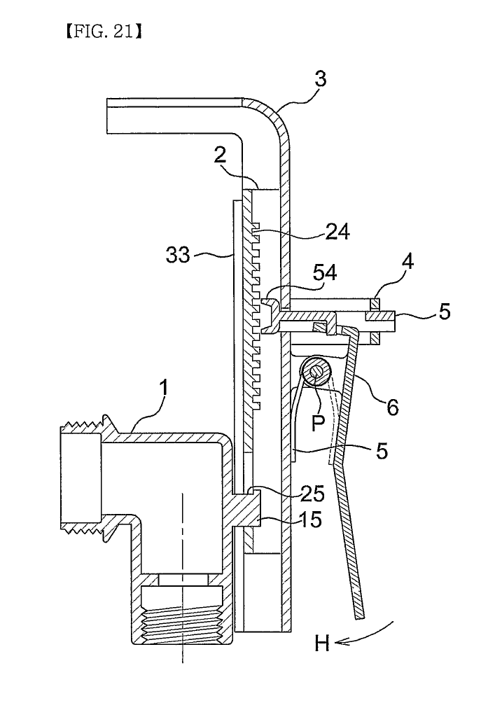

FIG. 21 is a view illustrating a state in which the installation position of the adapter 1 is adjusted using the device for raising and lowering an adapter which is assembled as described above.

With the frame 3 fastened to the ceiling as described above, if the installation position of the adapter 1 is not proper, the lever moving element 6 is pressed in the direction indicated by the arrow H using force greater than the spring force of the springs ‘s’ and employing a hand or a tool in a state in which the adapter 1 is supported using one hand. Then, the upper portion of the lever moving member body 61 of the lever moving member 6 is moved rightward (when viewed on the drawing) and moves the stop lever 5 rightward, as a result of which the engagement teeth 54 of the stop lever 5 are disengaged from the stopper grooves 24 of the slider 2, whereby the slider 2 and the adapter 1 are placed under a free state in which they can be freely moved upwards and downwards. In this free state, by manually raising and lowering the adapter 1, the precise installation position of the adapter 1 can be adjusted. If the precise installation position is set, by removing the external force applied to pull the lever moving member 6, the upper portion of the lever moving member 6 is moved leftward by the elastic returning force of the springs ‘s’, and the engagement teeth 54 of the stop lever 5 are engaged in the stopper grooves 24 of the slider 2, whereby the slider 2 and the adapter 1 cannot be moved upwards or downwards any more and are securely held in the fixed state.

In this fixed state, even when substantial external force or shocks are applied to the adapter 1 or the slider 2 or impulsive internal pressure is applied to the pipe fittings including the adapter 1, the adapter 1 and the slider 2 are reliably maintained in the securely fixed state and are prevented from moving upwards and downwards.

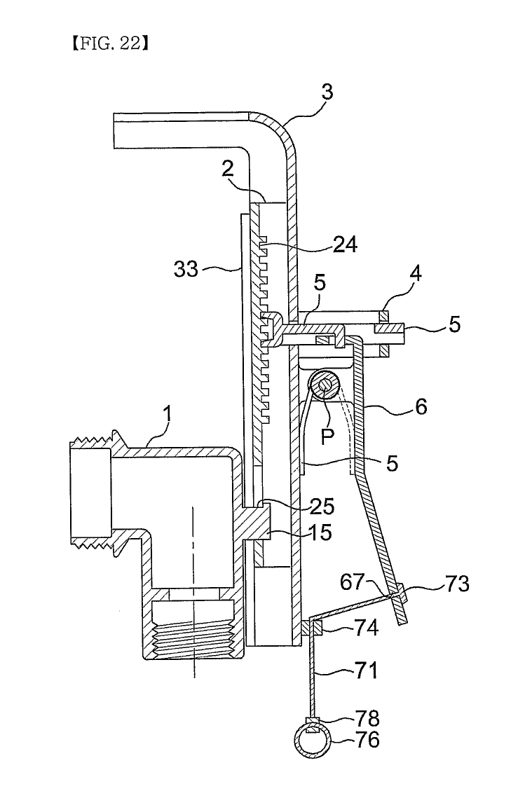

FIG. 22 is a view illustrating a state in which the auxiliary lever moving member 7 is assembled to the lever moving member 6.

When joining the auxiliary lever moving member 7 to the lever moving member 6, the guide part 74 of the auxiliary lever moving member 7 is attached to the frame body 31, and the manipulation cord 71 is passed through the hole 67 of the lever moving member 6 and the guide hole 75 of the guide part 74. Then, the other end of the manipulation cord 71 is fastened to the operation knob 76 as the knob 78.

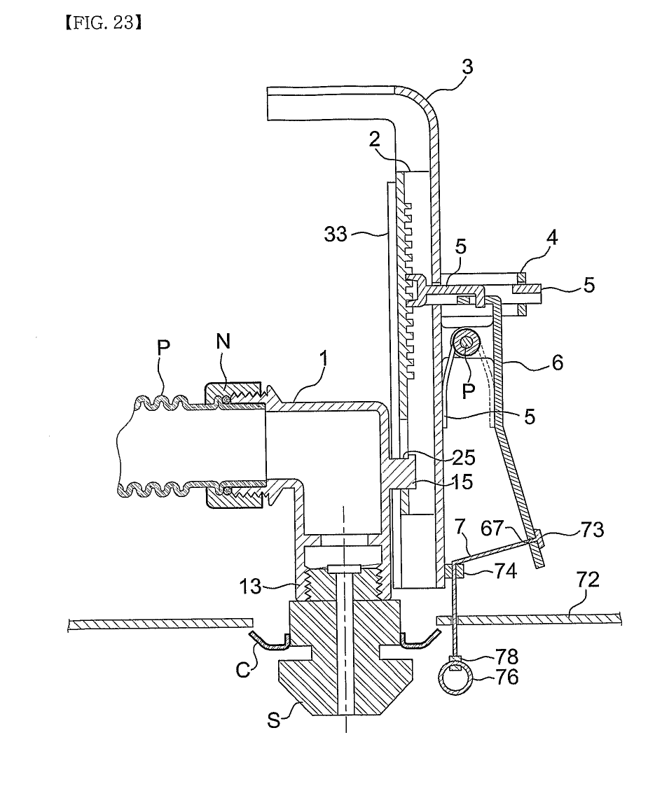

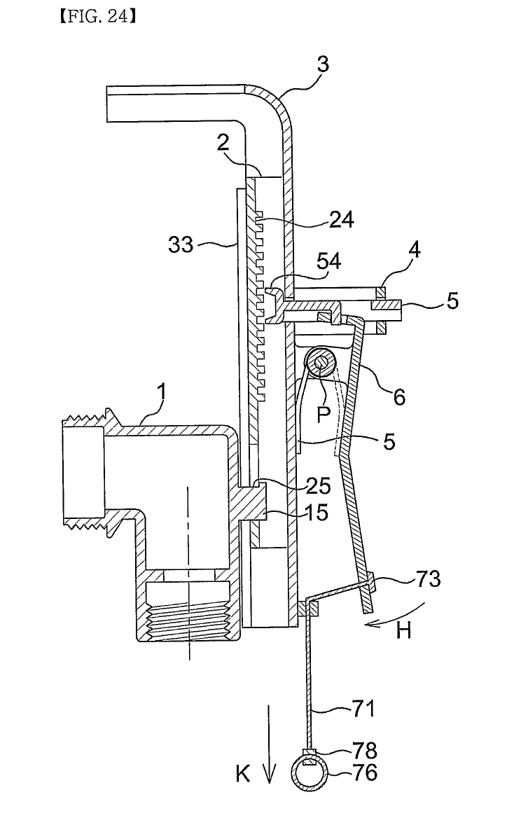

FIG. 23 is a view illustrating a state in which the device for raising and lowering an adapter shown in FIG. 22 is installed on the ceiling of a building, and FIG. 24 is a view illustrating a state in which the installation position of the adapter 1 is adjusted using the auxiliary lever moving member 7.

By pulling the operation knob 76 of the auxiliary lever moving member 7 in the direction indicated by the arrow K, the lever moving member 6 is pulled in the direction indicated by the arrow H about the hinge pins ‘p’. In this state, the height of the adapter 1 can be adjusted in the same way as described with reference to FIG. 21. If the height of the adapter 1 is set, by removing the force applied to pull the operation knob 76, the lever moving member 6 returns to an original position, and the adapter 1 can be maintained in the fixed state in the same manner as described in FIG. 21.

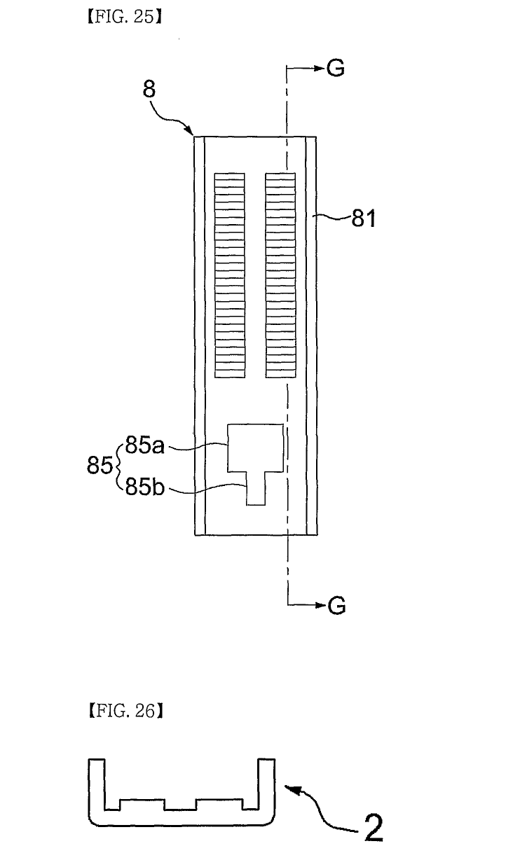

FIGS. 25 through 27 are a front view, a bottom view and a sectional view illustrating a variation of the structure of the slider which can be moved upwards and downwards along the frame, in the device for raising and lowering an adapter in accordance with the present invention.

A slider 8 according to this variation has a body 81 on which a plurality of stopper grooves 84 are defined in plural rows. Therefore, by defining the stopper grooves 84 in at least two rows, the number of places where the stop lever is engaged in the slider 8 can be increased, whereby the installation position (height) of the slider 8 can be further finely divided to have a smaller unit size. Also, even when substantial shocks or pressure is externally or internally applied to the slider or adapter, the slider and the adapter can be more reliably maintained in the fixed state.

An adapter fastening part 85 for fastening the adapter 1 is formed in the slider body 81. The adapter fastening part 85 has an adapter fitting groove 85a at the upper portion thereof and an adapter fastening groove 85b at the lower portion thereof, such that the fastening part 15 of the adapter 1 can be fitted into the adapter fitting groove 85a and then the adapter 1 can be lowered and firmly fastened in the adapter fastening groove 85b.

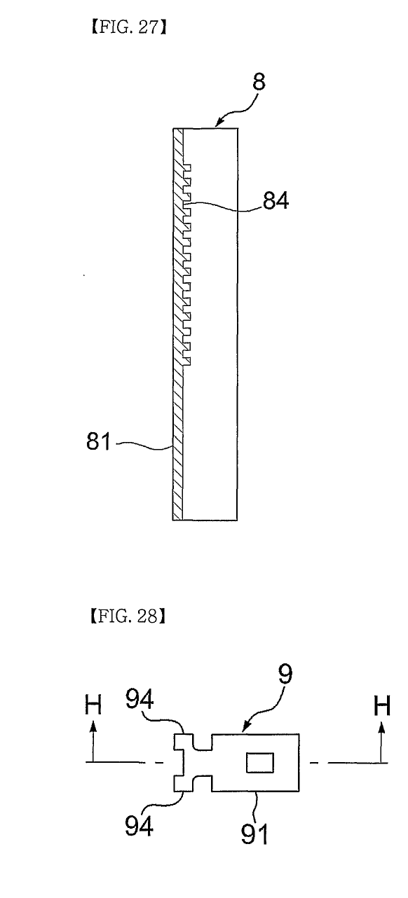

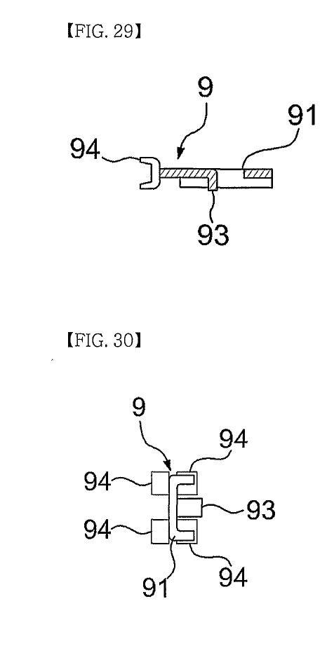

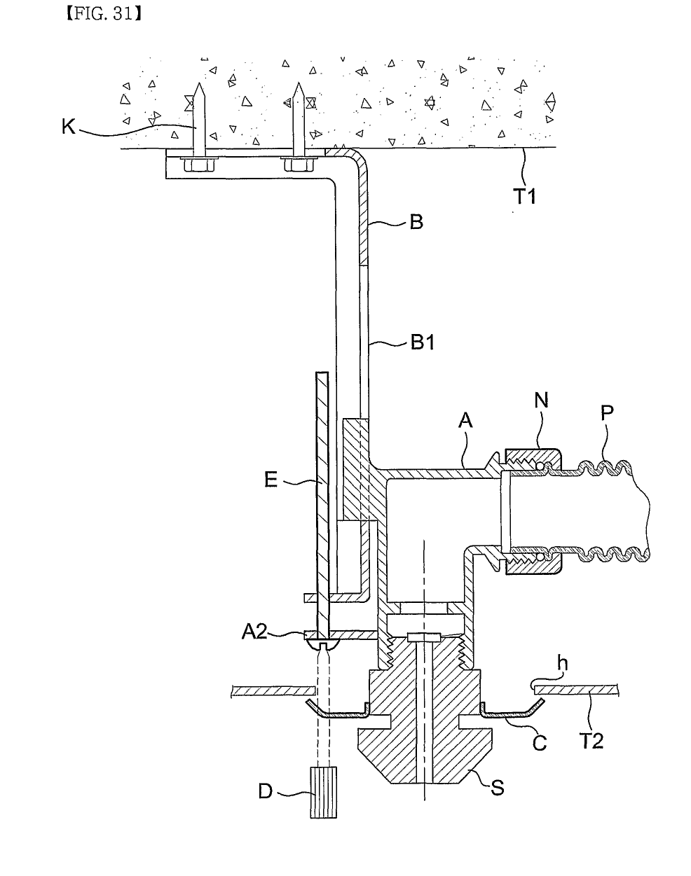

FIGS. 28 through 30 are a plan view, a sectional view and a right side view illustrating a variation of the stop lever which can be engaged in the slider 8 structured as just described above, in the device for raising and lowering an adapter in accordance with the present invention.

A stop lever 9 according to this variation has a body 91 on which a hook 93 for being fitted into the hook assembling part 63 of the lever moving member 6 is formed. Engagement teeth 94 for being engaged in the two rows of stopper grooves 84 of the slider 8 are formed in two rows on one end of the stop lever body 91.

### INDUSTRIAL APPLICABILITY

As described above, by forming the engagement teeth of the stop lever in plural rows and defining the plurality of stopper grooves of the slider in plural rows, when initially or continuously using a sprinkler or even when strong shocks or substantial water pressure is externally or internally applied to the sprinkler, the sprinkler set in the installation position is prevented from being moved out of the installation position, and the securely fixed state of the sprinkler can be reliably maintained.

1. A device for raising and lowering an adapter, comprising:
a slider having a body on which an adapter fastening part and a plurality of stopper grooves are formed;
a frame having a body on which a guide part, a first slide groove for guiding leftward and rightward movement of a stop lever, and hinge parts for assembling
a lever moving member are formed;
a lever bracket having a body which is secured to the frame and in which a second slide groove for guiding the leftward and rightward movement of the stop lever is formed;
the stop lever having a body on which a hook is formed and on an end of which engagement teeth are formed; and
the lever moving member having a body on which a hook assembling part for fitting the hook and hinge parts are formed;
wherein the slider having an adapter fastened thereto is assembled to the frame such that the slider can be raised and lowered, and the hinge parts of the lever moving member having the stop lever assembled thereto are assembled to the hinge parts of the frame by way of springs,
whereby the stop lever is always biased toward the stopper grooves of the slider by spring force of the springs so that the engagement teeth of the stop lever are engaged in the stopper grooves so as to maintain the slider in a fixed state, and when the stop lever is moved rightward by manipulating the lever moving member, the engagement teeth of the stop lever are disengaged from the stopper grooves of the slider so that the slider can be freely raised and lowered.

2. The device according to claim 1, wherein an auxiliary lever moving member, which has a manipulation cord, a connection piece, a guide part having a guide hole defined therethrough, and an operation knob, is provided in a manner such that the manipulation cord of the auxiliary lever moving member passes through a hole defined in the lever moving member and the guide hole of the guide part, and one end of the manipulation cord is knotted to the operation knob.

3. The device according to claim 1, wherein the plurality of stopper grooves are defined in plural rows on the slider, and the engagement teeth of the stop lever are formed in plural rows so that they can be engaged in the stopper grooves defined in the plural rows in the slider.
